(19) United States
(12) Patent Application Publication
(10) Pub. No.: US 2014/0126182 A1
(43) Pub. Date: May 8, 2014

(54) ILLUMINATED DEVICE

(71) Applicant: GRAND EFFECTS, INC., Irvine, CA (US)

(72) Inventor: Kevin Eugene Doud, Irvine, CA (US)

(73) Assignee: GRAND EFFECTS, INC., Irvine, CA (US)

(21) Appl. No.: 14/071,063

(22) Filed: Nov. 4, 2013

Related U.S. Application Data
(60) Provisional application No. 61/721,825, filed on Nov. 2, 2012.

(51) Int. Cl. F21V 33/00

(52) U.S. Cl. CPC F21V 33/0004
USPC 362/96

(57) ABSTRACT

An illuminated device comprising a housing, a light source within the housing, and at least one of a water stream element and a flame element supported within the housing. Some embodiments of the housing can have one or more walls, an upper portion, an opening through the upper portion thereof, and a plurality of stone pieces covering the at least one wall and upper portion of the housing. The stones can be at least partially translucent such that the light emitted from the light source is visible through the stones. Each light source is configured to emit a light toward at least the one or more walls. The water stream element is configured to project a stream of water through the opening in the upper portion of the housing, and the flame element is configured to project a flame through the opening in the upper portion of the housing.

### CROSS-REFERENCE TO RELATED APPLICATIONS

This application claims the benefit of U.S. Provisional Application No. 61/721,825, filed Nov. 2, 2012, the contents of which are hereby incorporated by reference in their entirety as if fully set forth herein.

### BACKGROUND OF THE DISCLOSURE

1. Field of the Disclosure

The present disclosure relates to illuminated decorative devices capable of emitting water streams and/or one or more flames.

2. Description of the Related Art

Water fountains, fire elements, and lighting can be used to accent indoor and/or outdoor areas. Conventionally designed devices do not provide the combination of features and capabilities of the embodiments of the devices disclosed in the present application.

### SUMMARY OF THE DISCLOSURE

Some embodiments are directed to an illuminated device having a housing or enclosure with lights therein, the lights being visible through the walls of the housing of the illuminated device. The device can be configured to propel a stream of water, champagne (such as in a champagne fountain) or any other suitable beverage or liquid from inside the housing (all such liquids are collectively referred to herein as water, such that the use of the term water is meant to represent any of the foregoing or any suitable liquid that can be emitted from the fountain). In some embodiments, the housing can be formed from or covered with decorative stones that are illuminated by the lights positioned inside the housing.

Some embodiments are directed to an illuminated device having a housing with lights therein, configured to project water provided from a pool pump or other external pump device through a nozzle thereof, and emit a stream of the water to a position outside of the fixture. The housing can be can be formed from or covered with decorative stones that are illuminated by the lights positioned inside the housing.

Some embodiments are directed to an illuminated device having a housing with lights therein, the lights being visible through the walls of the housing. The device can be configured to expel a flame from inside the housing. The housing can be can be formed from or covered with decorative stones that are illuminated by the lights positioned inside the housing.

In any embodiments disclosed herein, the housing can be sized and configured to be placed on a column, a bench, a wall, or other similar structure, or positioned on the ground. For example, in some embodiments, the device can be positioned to rest on top of a wall or a bench adjacent to a pool or other body of water and be configured to emit a stream of water from within the device into the external pool or body of water.

Some embodiments are directed to an illuminated device and/or a method of operating same, the illuminated device comprising a housing, a light source within the housing, and at least one of a water stream element and a flame element supported within the housing. Some embodiments of the housing can have one or more walls, an upper portion, an opening through the upper portion thereof, and a plurality of stone pieces covering the at least one wall and upper portion of the housing. The stones can be at least partially translucent such that the light emitted from the light source is visible through the stones. Each light source is configured to emit a light toward at least the one or more walls. The water stream element is configured to project a stream of water through the opening in the upper portion of the housing, and the flame element is configured to project a flame through the opening in the upper portion of the housing.

Some embodiments are directed to an illuminated device, comprising a housing having one or more walls, an upper portion, an opening through the upper portion thereof, and a plurality of stone pieces covering the at least one wall and upper portion of the housing, one or more light sources positioned within the housing, each of the one or more light sources being configured to emit a light toward at least the one or more walls, and a flame element supported within the housing configured to project a flame through the opening in the upper portion of the housing. The stones can be attached to a base layer of the housing using the Marquetry Inlay technique or can form the walls of the housing without a base layer. Additionally, the flame element can comprise an ignition module, a burner, a valve, and a solenoid configured to adjust a position of the valve to control a flow of combustible gas through the burner.

### BRIEF DESCRIPTION OF THE DRAWINGS

Embodiments of the present disclosure will now be described hereinafter, by way of example only, with reference to the accompanying drawings in which:

FIG. 1 is a perspective view of an embodiment of an illuminated device configured to emit light, one or more water streams, one or more flames, or any combination of the foregoing, the device having a generally square cross-sectional shape.

FIG. 2 is a perspective view of another embodiment of an illuminated device configured to emit light, one or more water streams, one or more flames, or any combination of the foregoing, the device having a generally circular cross-sectional shape.

FIG. 3 shows an embodiment of an illuminated device configured to emit a stream of water from within a housing of the device.

FIG. 4 shows the components of the illuminated device embodiment shown in FIG. 3 that can be supported or positioned within the housing.

FIG. 5 shows another embodiment of an illuminated device configured to emit a flame from within the housing of the device.

FIG. 6 is an illustration of the components of the illuminated device embodiment shown in FIG. 5 that can be supported or positioned within the housing.

FIGS. 7A, 7B, and 7C show a top view, section view and a perspective view, respectively, of an embodiment of a housing (or a portion thereof) that can be used with any of the illuminated device embodiments disclosed herein.

FIGS. 8A, 8B, and 8C show a top view, section view and a perspective view, respectively, of another embodiment of a housing (or a portion thereof) that can be used with any of the illuminated device embodiments disclosed herein.

FIG. 9 shows an embodiment of a base member that can be used with any of the illuminated device embodiments disclosed herein.

FIG. 10 shows an embodiment of a collar member that can be used with any of the illuminated device embodiments disclosed herein.

FIG. 11 shows an embodiment of a controller that can be used with any of the illuminated device embodiments disclosed herein.

FIG. 12 shows another embodiment of a controller that can be used with any of the illuminated device embodiments disclosed herein.

### DETAILED DESCRIPTION OF THE PREFERRED EMBODIMENT

Embodiments disclosed herein relate to illuminated devices that can be used for decoration and entertainment. For example, some embodiments disclosed herein relate to an illuminated decorative device which can be configured to emit a controllable and adjustable stream of water and/or a controllable and adjustable flame from within a decorative illuminated housing thereof. Any embodiments can have a light source or fixture supported within the housing and configured to illuminate one or more walls of the housing with any number of different colored lights. The color and illumination of the lights can be adjustable and programmable.

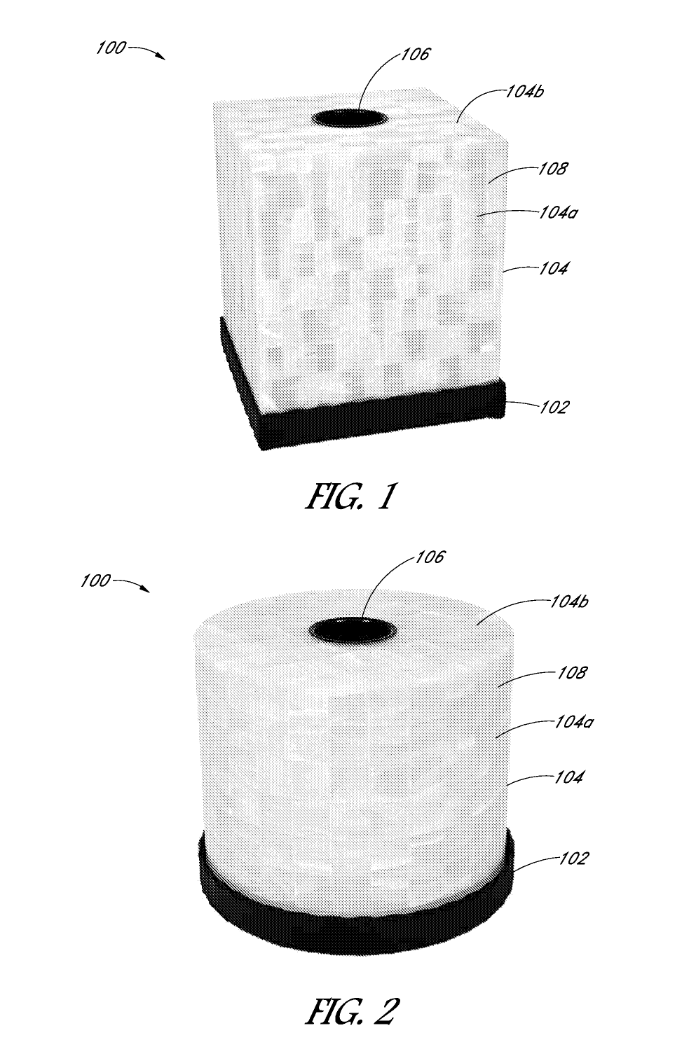

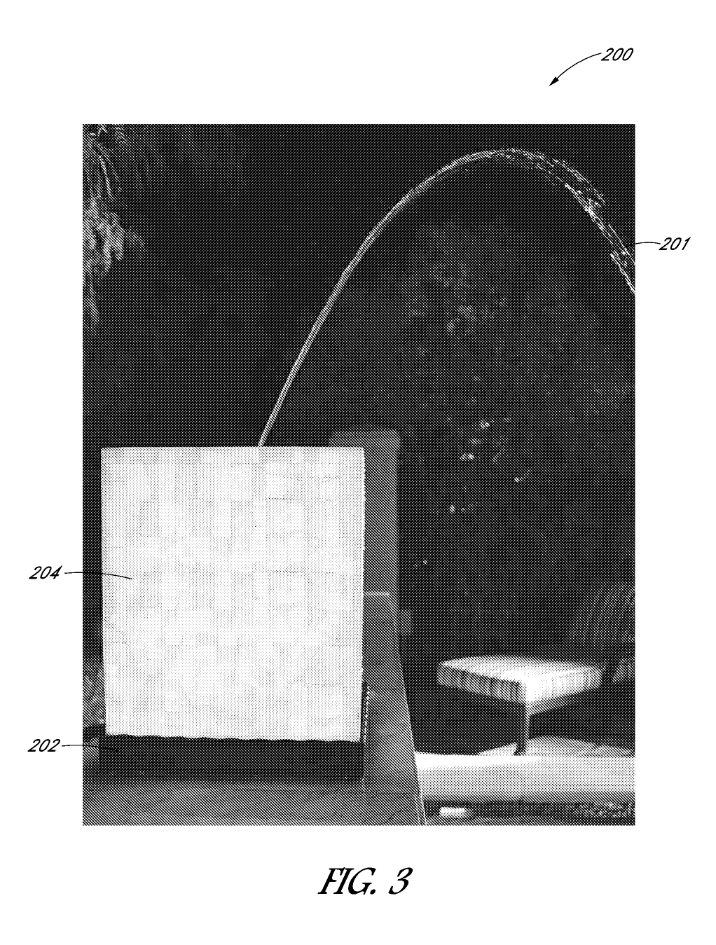

FIGS. 1 and 2 are perspective views of an embodiment of an illuminated device configured to emit light, one or more water streams, one or more flames, or any combination of the foregoing having a generally square cross-sectional shape and a generally circular cross-sectional shape, respectively. With reference to FIG. 1, any embodiments of the illuminated device 100 disclosed herein can have a base 102, a housing 104 having one or more side surfaces 104a and a top surface 104b, a thermal ring or collar 105, and one or more openings 106 (one being shown) formed in the top surface 104b thereof. The collar 105 can be positioned adjacent to the opening at the top end of the housing, or adjacent to any opening that can be formed in the housing in any surface thereof, including a side wall surface. As will be discussed, the one or more openings 106 can be used to permit one or more streams of water or one or more flames emanating from inside the housing to pass through the opening into the ambient air, and can be positioned in any desired surface of the housing, including the top surface and/or one or more side surfaces of the housing.

In any embodiments disclosed herein, the housing 104 can have a plurality of side walls 104a defining any desired shape. In the embodiment illustrated in FIG. 1, the side walls 104a define a generally square or rectangular shape and the top surface 104b also can have a generally square or rectangular shape. In the embodiment of the illuminated device 100 illustrated in FIG. 2, the side walls 104a have a generally cylindrical shape and the top surface 104b defines a generally circular shape. However, the side walls of any illuminated device embodiments disclosed herein can have any desired shape, including being generally ovular in shape, polygonal in shape (including pentagonal, hexagonal, octagonal, or otherwise), or even having any desired curved shape.

Additionally, in any embodiments disclosed herein, the housing can be formed from, or tiled or covered with, stones (such as white quartz stones or white onyx) to provide a decorative look to the housing. In any embodiments disclosed herein, the devices can be configured to emit one or more flames, one or more water streams, one or more lights within the device to illuminate the walls of the device internally and therethrough, or any combination of the foregoing.

FIG. 3 is an illustration of an embodiment of an illuminated device 200 configured to emit a stream of water 201 from within a housing 204 of the device 200. The stream of water can be directed to an external body of water, such as a pool, that can surround or be adjacent to the device. Any embodiments of the device 200 illustrated in FIG. 3 can have any of the lights, features, configurations, components, or other details of any of the other illuminated device embodiments disclosed herein, in combination with or in the alternative to any of the lights, features, configurations, components, or other details described below.

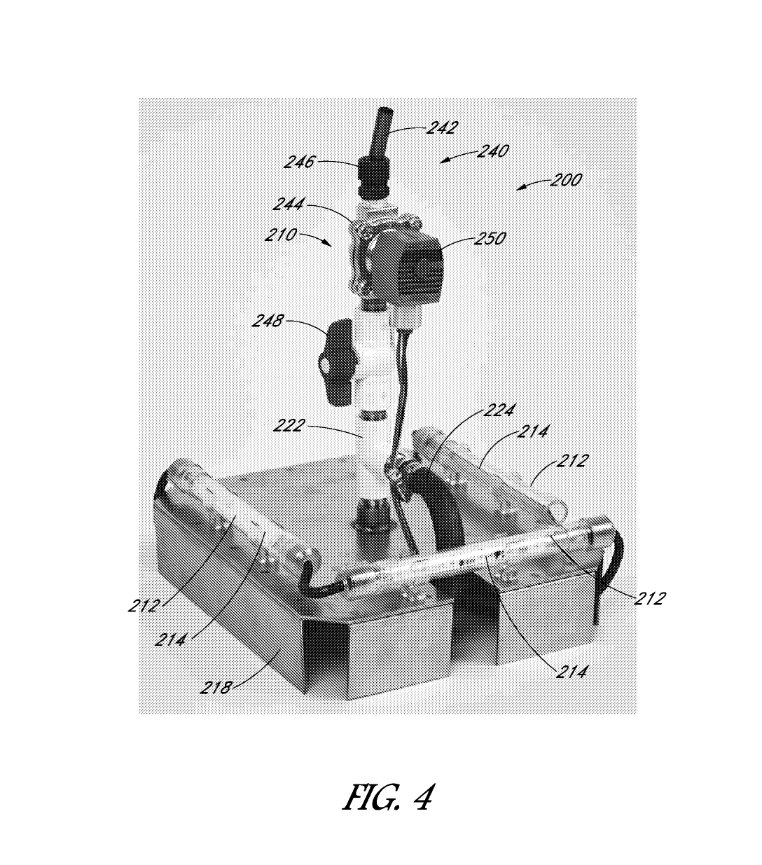

FIG. 4 is an illustration of the components of the illuminated device 200 shown in FIG. 3 that can be supported or positioned within the housing (not illustrated in FIG. 4), including a water stream element 210 that is described in greater detail below and one or more light sources 212. The embodiment of FIG. 4 has three separate light tubes 214 supported by a frame element 218 of the device 200. Each having a plurality of light tubes 214 can be supported along three edges of the frame 218, respectively. The light tubes 214 can be designed and configured to protect one or more light sources within the respective tubes 214. If desired, an additional light tube can be positioned along the fourth side of the frame 218. In any of the embodiments disclosed herein, the light sources can be positioned in any desired location on the frame or otherwise. As shown, the frame 218 can also support one or more components of the water stream element 210 and any conduit 222 or tubing 224 required to provide a source of water to the water stream element. Additionally, as will be discussed in greater detail below, the frame can also support one or more of valves, a transformer, controller, solenoids, and/or other electronic components for the light sources and the water stream element.

In any embodiments herein, the frame 218 can be sized and shaped to match or complement the size and shape of the housing 204 that can be positioned on top of, over, and/or around the frame 218. Similarly, the housing 204 can be sized and shaped to match or complement the size and shape of the frame 218.

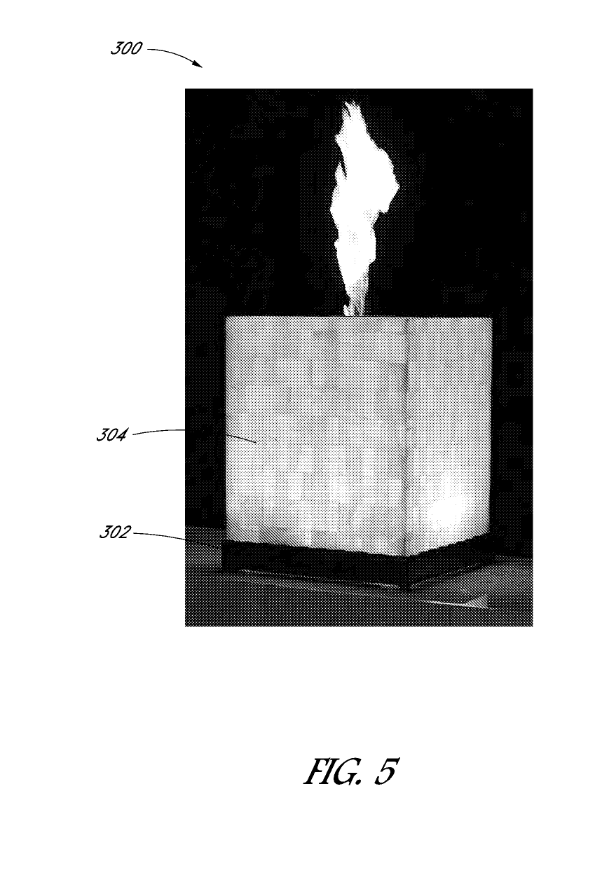

FIG. 5 illustrates another embodiment of an illuminated device 300 configured to emit a flame from within the housing 304 of the device 300, and FIG. 6 is an illustration of the components of the device 300 that can be supported or positioned within the housing 304. Any of the illumination device embodiments disclosed herein can have a flame element 310, as described in greater detail below, and one or more light sources 312. As with any other embodiments described herein, the illuminated device can have any number of lights supported by a frame member of the device. For example and without limitation, the illuminated device 300 can have three separate light tubes 314 each having a plurality of lights therein supported by a frame 318 along three edges of the frame, as in the illuminated device 200 described above. If desired, an additional light tube can be positioned along the fourth side of the frame. As shown, the frame can also support one or more components of the flame element 310 and any conduit or tubing 322 required to provide a source of combustible gas to the flame element 310. Additionally, a transformer for the light sources can be supported by the frame 318 or can be positioned adjacent to the illumination device, or otherwise.

In any of the embodiments disclosed herein, the lights of such embodiment can be supported by the frame in a manner that permits the lights to be rotated to maximize an even light output on the walls of the housing and to minimize hot spots on the walls of the housing that might otherwise result from a high concentration of light on one spot of the housing. Two, three, or more white or colored light sources (which can comprise one or a plurality of LED lights, respectively) can be supported within the housing to reduce shadows or hot spots. The lights can be angled so that the focal point of each light is approximately 15 degrees off vertical, toward the wall of the housing, or between approximately 10 degrees and 30 degrees or more. The number of lights mounted on or supported by the frame is important to the distribution of light throughout the stone. In some embodiments, the housing can support three light tubes or sources, or between one and three light tubes or sources, or between 2 and four or more light tubes or sources. Each of the light tubes or sources can comprise any desired number of individual lighting elements, which can comprise fluorescent, LED, halogen, or other types of lights. For example, in some embodiments, the light sources can have a tubular shaped housing or protective cover, and can comprise between four and six LED lights or other lights supported within the protective cover. The protective cover can be clear or can have any desired color so as to change a color of the light being emitted from the light source.

The light sources can have any desired shape or configuration, including light strips, light tubes, one or more light rings extending around some or all of a perimeter of the frame member, discrete light sources, or otherwise. Any of the light sources can be positioned at any desired location around a perimeter or peripheral portion of the frame member.

Therefore, in some embodiments, one or more light sources can be mounted within the fixture to shine through or illuminate the walls of the device (i.e., through the layers of stone). The lights can be configured to emit any desired color of light, including pink, red, orange, green, blue, yellow, white, any other desired color or any sequence or combination of any of the foregoing colors, into or through the walls of the housing. For example, the device can have a programmable control system configured to emit a series of different light colors, flashing lights, etc., such as the control system shown in FIG. 12. Additionally, in any embodiments disclosed herein, each of the light sources can be programmed to emit one or more different color lights in sequence or simultaneously. For example, the light source can have a light tube and a plurality of light elements (such as, but not limited to, LED light elements) supported within the tube, and can be configured such that each of the light elements can be controlled independently of the other light elements within the light tube to emit a different color or different pattern of light or light sequences.

As described, one or more surfaces of the housing of any embodiments disclosed herein can be formed from or covered with a decorative translucent or semi-translucent stone using a Marquetry Inlay technique configured to illuminate or allow passage of light therethrough when one or more lights are directed toward such surfaces. In some embodiments, an outer surface of the entire housing can be formed from or covered with decorative stones. The stones can be onyx, quartz, white quartz, or any other desired type of stone. In some embodiments, the stone can be a layered composite type stone, wherein each of the layers of stones are positioned adjacent to one another along the length of the stone such that each of the layers is visible, giving the stones a richer and improved decorative look. Each of the layers can be laminated together so as to form a single stone piece. Then each of the pieces can be positioned adjacent to one another to either form or cover the walls of the housing for the desired decorative look. In any embodiments herein, the stones can be adhered to a base layer of the housing that is configured to permit light to pass therethrough, such as glass, certain plastics, or otherwise, or a metal, glass, or ceramic mesh, or can form the housing without such a base layer.

Embodiments of the housing can have a rectangular shape, such as is shown in FIG. 1, a cylindrical shape, such as is shown in FIG. 2, or any desired shape. The device, if it has a rectangular shape, can be approximately 14.5 inches wide on either side and approximately 17 inches or more tall. However, the devices can be sized according to the desired application, such that the devices can be larger or smaller than the specific ranges disclosed herein. For example, in any embodiments, the device can have a rectangular shaped housing that is from approximately 10 inches wide to approximately 20 inches wide on either side, and from approximately 14 inches to approximately 24 inches tall. Embodiments of the device disclosed herein, having a cylindrical shaped housing, can have a housing with a diameter of approximately 17 inches in height of approximately 16 inches. In some embodiments, the device can have a cylindrical shaped housing having a diameter from approximately 12 inches to approximately 24 inches in height from approximately 12 inches to approximately 25 inches. As used in this disclosure, unless otherwise defined, the term approximately means plus or minus 10% of the stated value.

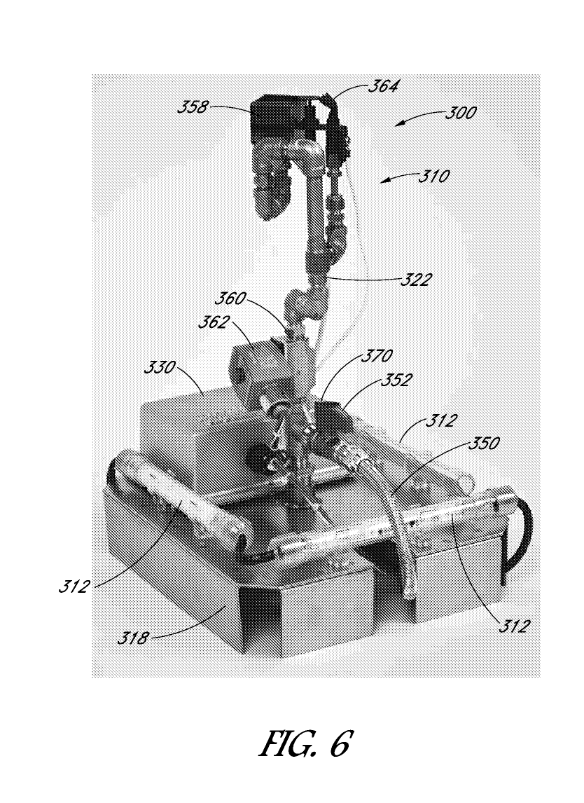

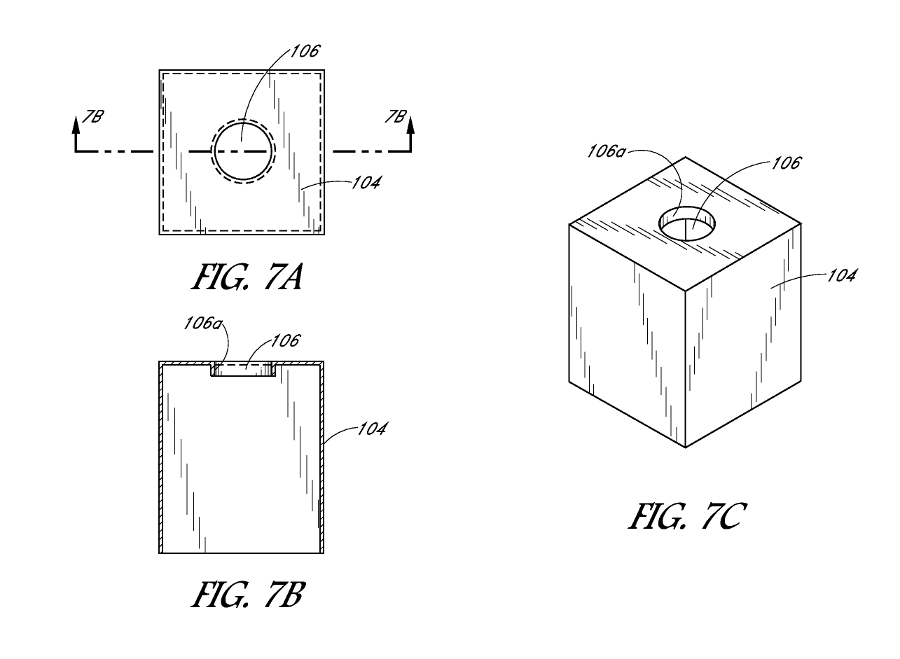

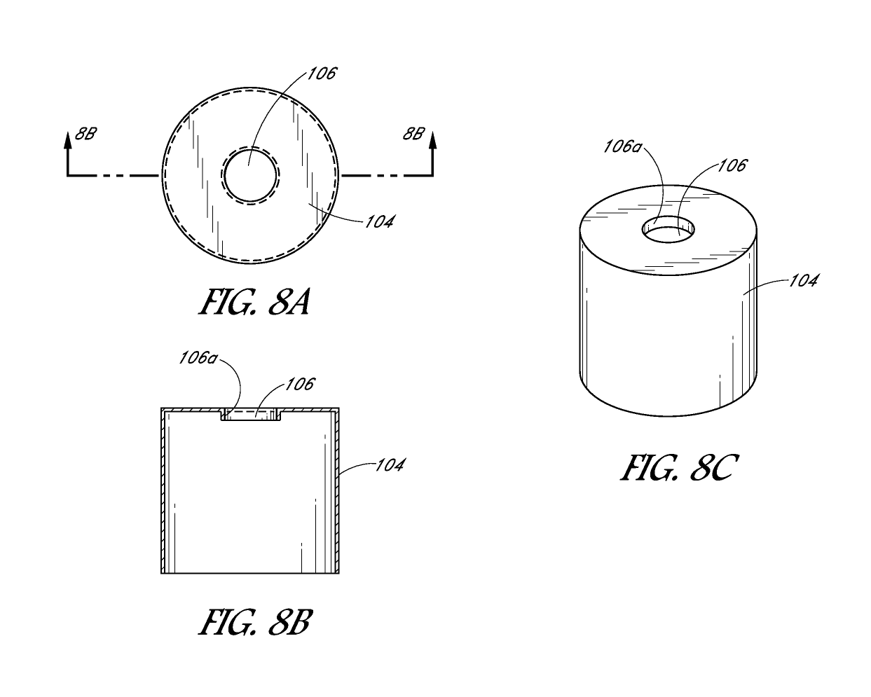

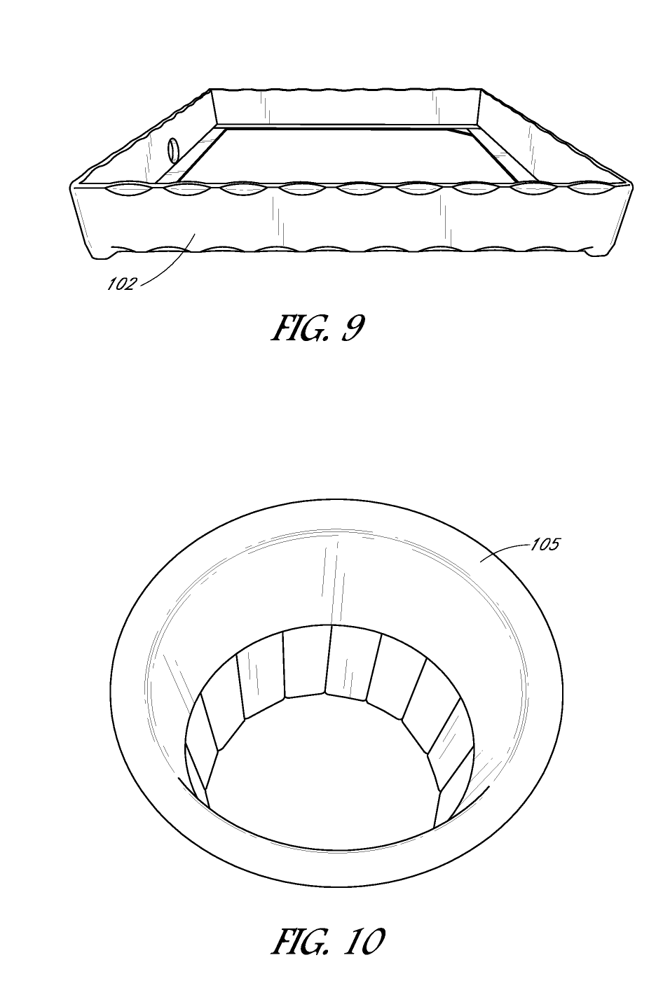

As mentioned, any of the housings disclosed herein can have one or more openings in a top surface of the housing, as shown in FIGS. 7-8. FIGS. 7A, 7B, and 7C show a top view, a section view, and a perspective view of a square or rectangular shaped housing 104, respectively. FIGS. 8A, 8B, and 8C show a top view, a section view, and a perspective view of a cylindrical shaped housing 104, respectively. As shown in FIGS. 7-8, the housing of any embodiments disclosed herein can have an opening 106 (or any number of openings 106) in a top surface of the housing 104. In any embodiments, the opening can comprise an approximately 5 inch diameter round opening in the center of the top surface of the housing, though the opening can have a square, rectangular, triangular, hexagonal, or any other desired shape. The opening can be configured to permit a water stream and/or a flame generated inside the housing to project or extend outside of the housing.

Additionally, the opening 106 can have a wall portion 106a adjacent thereto, extending into an inside portion of the housing 104. The wall portion 106a can provide additional strength and protection to the housing adjacent to the opening or any number of openings therein against thermal loading and stresses, physical stresses, hot spots or thermal concentrations that may otherwise comprise the strength of the housing adjacent to the opening. The wall portion 106a can have a cylindrical shape, as shown in FIGS. 7B and 7C, or can have any suitable shape that joins with the opening, such as opening 106. For example, if the opening is square shaped, the walls of the opening extending into the interior portion of the housing can have a generally square tubular shape. The wall portion can be covered with stones, or formed from stones. The wall portion can be approximately 1.25 inches long, extending into the interior space of the housing 104. Additionally, in any embodiments disclosed herein, the length of the wall portion can be approximately 1 inch or less, or from approximately 1 inch to approximately 2 inches or more.

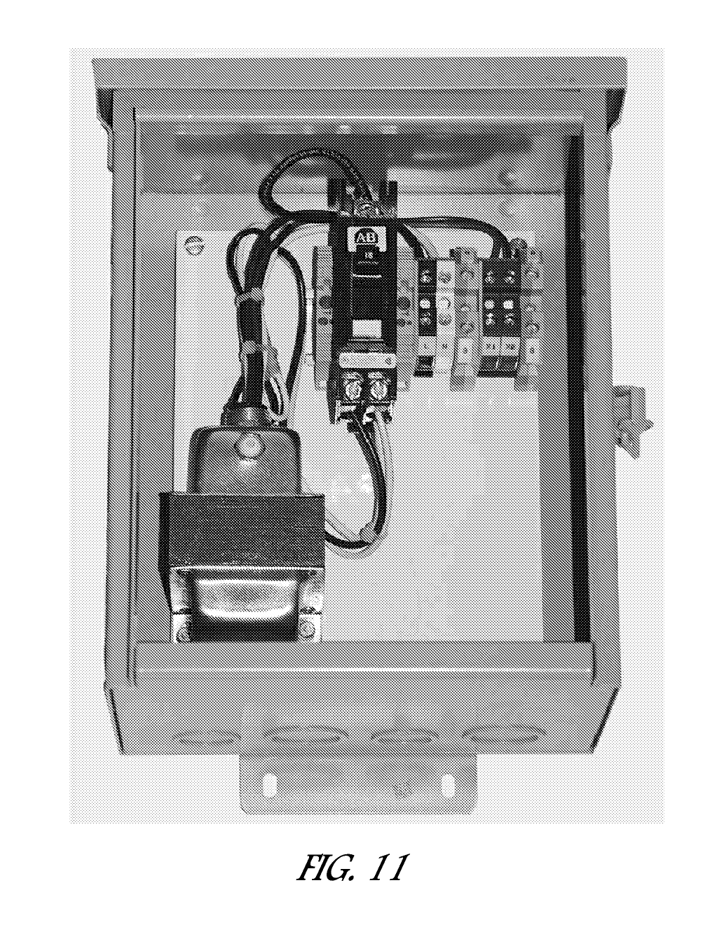

Any of the embodiments of the illuminated device can have a base member positioned at a bottom portion of the housing, such as the base member 102 shown in FIGS. 1 and 2. The base member can be formed from any suitable material, including without limitation metal (powder coated, painted, or otherwise), ceramic, plastic, a composite material, or any combination of the foregoing or other suitable materials. In some embodiments, the base can be powder coated or painted in any desired color, including brown or black. An embodiment of a base or base member is shown in FIG. 9. The base member 201 illustrated in FIG. 9 can be used to support a square shaped housing. However, the base member can be any desired shape needed to support any desired shaped housing or other components of the illuminated device. The base member can support the housing, the frame, and/or any other components of the illuminated device embodiments disclosed herein. The base member can locate the housing in a permanent, fixed position, at least in the lateral directions and also in a downward direction. The base can also be configured to permit rainwater, condensation, or water from the water element to drain from the device.

In some embodiments, the device can be configured to have an air gap (such as between the housing and the base) or opening that can permit a passage of air into the housing, to provide cooling to the components positioned within the housing. The air flow permitted by the gap or opening can prevent the burner electronics (flame circuit or other electronics) from overheating and/or can reduce the likelihood of overheating. In some embodiments, the base can support the lights and the components of the flame element and/or water stream element. In some embodiments, the base can also support the transformer, control system for the lights and gas or water components, and the housing or enclosure. The lights can be mounted or fixed to, or otherwise supported by, the base or frame in a manner that permits the lights to be individually turned, rotated, or otherwise adjusted to adjust the illumination of the housing or of the flame or water stream. For example, in some embodiments, the lights can be adjusted to maximize an even light output on the stone walls of the housing and to minimize hot spots on the stone that could result from a high concentration of light in one spot on the housing.

The housing can be configured such that the flame creates a natural draft of air that pulls in outside ambient air through the base (or the opening or gap in the base) and discharges it through an opening in the top of the housing, which opening can also be used for emitting the flame and/or water stream. This air movement can prevent or inhibit heat from building up inside of the housing and in the walls of the housing having decorative stone, and also can prevent or inhibit damage to the burner wiring and electronics. The base can be configured to support the housing in a fixed position. Additionally, the base can be configured to provide water drainage from rain water, condensation, or other water that collects inside of the housing or device. For example, the base can have one or more openings formed therein configured to permit the liquid to drain out of the housing and base. The base can be formed from a black or brown powder coated metal.

Any embodiments of the device can have a thermal barrier therein to prevent the walls of the housing from overheating from the one or more lights or flame element. For example, a thermal barrier collar, such as the collar member 105 shown in FIG. 10, can be supported by the housing to surround the opening in the housing through which the flame is emitted to prevent the flames and excess heat from the flame element from overheating the stone adjacent to the opening. In this configuration, the collar can prevent cracking or other damage to the stone. The collar can be made from any suitable metal or other material, such as flame retardant fiberglass, metal, ceramic, or otherwise. Though not required, collar can have a split formed either partially or fully therethrough or otherwise be configured to permit the expansion and contraction of the collar without warpage or buckling.

As described, any embodiments of the illuminated device disclosed herein can have a water stream module positioned within the housing, such as the water stream module 240 shown in FIG. 4. The water stream module can be configured to emit a stream of water from within the housing to a position outside of the housing. The device can have a transformer and/or any other electrical components needed to reduce 110 volt electricity to a lower voltage, such as 24 volts. Additionally, any embodiments disclosed herein can have a water stream element having a water source or a pump (not illustrated), one or more nozzles (such as the nozzle 242 shown in FIG. 4), one or more flow control valves (such as the flow valve 244 shown in FIG. 4), a swivel 246 to permit angular and/or directional adjustability of the nozzle, a water shut-off or pressure control valve (such as the valve 248 shown in FIG. 4) to control the flow of water into the nozzle. Any of the illumination devices disclosed herein can have one or more solenoids 250 configured to move or adjust the one or more valves 244 or the valves used to control a flow of gas for the flame element. The solenoids are discussed in greater detail below. In some embodiments, the pump can be configured to provide 5 gallons per minute of water to the nozzle.

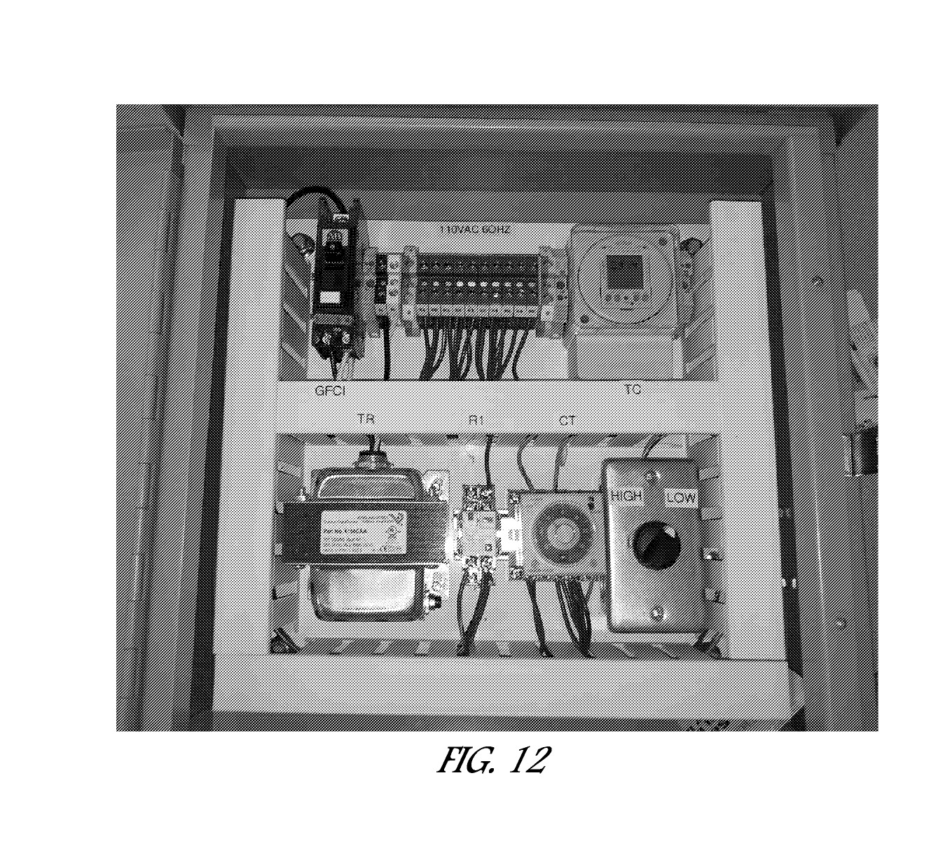

Any of the illumination device embodiments disclosed herein can have a controller configured to control operation of the water stream element, to adjust the programming for the water shows that can be performed by the water element, and/or to control the lights within the housing. One example of a control system that can be used with any of the embodiments disclosed herein is shown in FIG. 11. The device can also have a user interface in communication with the controller.

As mentioned, one or more solenoids can be used to turn the water stream element or flame element on or off (or to adjust a flow rate of the fluid or gas flowing through the water stream element or flame element) by opening or closing a valve to control the flow of the water stream during, for example, a programmed water show, or to turn the flame on or off by opening or closing a valve in communication with a combustible gas valve during a programmed fire show. In some embodiments, the nozzle can be a laminar or jet type of water nozzle, and the other components of the water stream module can be sized and configured to accommodate the water flow requirements of either of such nozzle types. Any of the components or features described herein for the water stream element can be used or configured for use with the flame element, including without limitation any of the nozzle, solenoid, user interface components, and controller components or features disclosed herein, and vice versa.

The device can have a control system (such as the control system shown in FIG. 11) configured to at least control an operation of the stream of water so that the stream can be emitted in discontinuous patterns, to power the system on and off, at a variety of heights and distances, at a variety of angles, and to a variety of locations, or any combination of the foregoing. Additionally, the water stream can follow any of a number of preprogrammed patterns that can be selected on the user interface using one or more switches.

A PLC (programmable logic controller) can be used to control the operation of the water stream or flame during a programmed water show or fire show. Additionally, in any of the embodiments of the device disclosed herein, the controller can have a timer feature permitting a user to program, for example, the time of day that the device operates and the time of day that the device turns off.

As mentioned, the controller can be configured to permit a user to control amplitude, direction, and other parameters of the water stream element for each of the one or more water stream nozzles or elements, to control the frequency and duration of intermittent water streams, the lights within the housing (as described in combination with any other embodiments disclosed herein), or any other components of the device. The controller can have any number of predefined programs for providing a light and water stream show for the user, or permit a user (through the user interface) to select any combination of effects desired. In some embodiments, the controller can have three or more different show modes having seven or more different colors that a user can select from. The user interface can have one or more switches, dials, buttons or other user interface components configured to permit a user to control an operation of the device.

In some embodiments, the water stream element can be configured to utilize an external pump mechanism, such as a pump from a pool, to pressurize the water to emit the water from the housing in a stream. The pump and lights can be operated remotely from any control system, including a pool control system, a control system or remote control particular to the fixture, or otherwise. In some embodiments, the device can be configured such that one or more of the lights can shine into or through the water stream to illuminate the water stream also.

As mentioned, any embodiments of the device can have a flame element supported therein configured to emit a flame from within the fixture, in addition to the standard light source components. In any embodiments disclosed herein, the flame element (such as the flame element 310 shown in FIG. 6) can have an inlet conduit 350, a first valve 352 (that can be used to shut-off or adjust a flow rate of combustible gas flowing into the flame element), a gas burner 358, a controllable valve 360 that can be operated by a solenoid 362, an igniter or pilot 364, an inlet connection or manifold 370 configured to receive flammable gas from an external source, such as a natural gas line or tank, a propane gas line or tank, or otherwise. Each device can have a plurality of or any desired number of flame elements. In some embodiments, the device can be sized and configured to support a propane or other combustible gas tank within the housing or adjacent to the housing. In some embodiments, the device can have a plurality of flame elements or a plurality of flame nozzles, igniters, and valves to permit the device to emit a plurality of independently controlled flames.

Therefore, some embodiments of the device can have a housing (such as any of the housing embodiments described above), one or more lights (such as any of the lights described above or combinations of lights described above), a transformer, a flame element capable of 5,000-25,000 Btu/hr, a control panel (such as, without limitation, a U.L. approved control panel). In any embodiments disclosed herein, the flame element can have a gas burner such as, without limitation, a CSA approved burner system with flame monitoring technology or a flame monitoring system configured to detect the presence or absence of a flame and output a signal, such as to the controller. The lights and/or flame element of the device can be configured to be operated remotely from any home or pool operating or control system, or as described above. In some embodiments, the device can demand a gas flow of approximately 6,500 Btu/hr or less, or as much as 25,000 Btu/hr or more.

Additionally, as mentioned above, the device can have a control system configured to control an operation of the gas burner or flame that is emitted from the gas burner so as to emit the flame in discontinuous patterns, at a variety of heights, or any combination of the foregoing. The burner and lights can be operated remotely from any control system, including a pool control system, a control system or remote control particular to the fixture, or otherwise.

Some embodiments of the device can be configured to provide a fire show for the user's enjoyment. For example, the device can have an automated burner system controlled by a pre-programmed or user programmable control system configured to control an amplitude and/or direction of the flame emitted by the device, to power the system on or off, a light show (as described above), and any combination of light colors and sequences and flame amplitude and direction. Additionally, in some embodiments, the control system can be used to control an operation of a plurality of independently controllable flame devices or components of the flame device, such as a plurality of valves, igniters, nozzles, or other components so that multiple flames can be emitted and independently controlled by a user or in accordance with a pre-programmed flame show, as well as any combination of lighting or lighting programs desired such as light coloring, sequence of different colored or same colored lights, brightness, or any combination of the foregoing.

The gas manifold can be sized to accommodate the gas flow requirements of the burner nozzle. The burner automation can have a flame circuit to light the burner in a safe manner and monitor the status of the flame. In some embodiments, the device can have an ignition module 330 having a milliamp flame circuit, which can be a conventionally available ignition module such as a Honeywell ignition module. The ignition module can be configured to reignite a pilot light if the pilot light extinguishes due to wind or rain, or otherwise. The valve can be configured to shut off in the event the pilot light is extinguished or otherwise not lit.

In some embodiments, the device can have one or more of the components for the flame element in combination with one or more of the components for the water stream element, in addition to any of the control system components disclosed herein supported within the housing such that the water elements in the flame element can be used simultaneously.

Any of the embodiments of the devices disclosed herein can be powered by any suitable or available sources of electricity or power. For example, some embodiments of the device can be powered by electricity from standard residential or other electrical circuits, by disposable or rechargeable batteries supported within the housing, by photovoltaic panels or cells used independently or in combination with one or more rechargeable batteries that can be charged by the photovoltaic power, and/or in combination with power provided by standard residential or other electrical circuits. The photovoltaic panels or cells, if used, can be positioned at a remote position as compared to the housing.

In some embodiments, the housing can be configured to support a signal receiver to receive a signal from a remote control to control an operation of the device, including the operation of the lights, flame element, and/or water stream element. For example, a user can control the brightness of the lights, the color of the lights, the sequence of any color light show, any pre-defined or user defined light show program, or any combination of the foregoing. Additionally, the remote control can be configured to control an operation of the fire element or the water stream element, such as the amplitude of the flame or water jet, direction of the flame or water stream, any programs used to enhance the user's experience with the flame or water stream such as programs that change the amplitude and/or direction of the flame or water stream, frequency and amplitude of any intermittent bursts of flame or water, or any combination of the foregoing. In some embodiments, the remote control can operate through the owner's pool controller or other residential system controller, which can then send a signal to or otherwise interface with the controller of the device to control an operation of the device.

In some embodiments, the remote control can be a user's smart device, such as an IPHONE, IPAD, smart phone, or even the control system for a user's pool or exterior lights. Additionally, the housing can be configured to support a hardwired control panel or user interface to permit a user to control any of the foregoing aspects of the device. Further, a hardwired control panel or user interface can be tethered to the device for remote installation or mounting.

One embodiment of a control system that can be used to control an operation of the lights, water element, and/or flame element is illustrated in FIG. 11. As shown therein, the control panel can have a GFI (ground fault interrupter) circuit with a 15 Amp breaker in communication with a transformer, the transformer being configured to reduce the voltage of the input from, for example, 110 volts to a lower voltage such as 24 volts, that can be provided to other components of the system. For example, the 24 volts of electricity from the transformer can be provided to the ignition module of the fire element. The ignition module can be a commercially available Honeywell ignition module. The controller can interface with the controller for the pool or other residential systems, such as lighting. Additionally, a plurality of illumination devices can be interconnected, such as in series. For example and without limitation, six or more illumination devices can be interconnected in a daisy chain configuration.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some embodiments, the actual steps taken in the processes illustrated and/or disclosed may differ from those shown in the figures. Depending on the embodiment, certain of the steps described above may be removed, others may be added. Accordingly, the scope of the present disclosure is intended to be defined only by reference to the appended claims. The accompanying claims and their equivalents are intended to cover such forms or modifications as would fall within the scope and spirit of the protection. Furthermore, the features and attributes of the specific embodiments disclosed above may be combined in different ways to form additional embodiments, all of which fall within the scope of the present disclosure. Although the present disclosure may describe particular embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims. Therefore, the protection is not restricted to the details of any foregoing embodiments. The disclosure herein encompasses any novel one, or any novel combination, of the features disclosed in this specification (including any accompanying claims, abstract and drawings), or to any novel one, or any novel combination, of the steps of any method or process so disclosed and the protection sought by this application extends to same.

What is claimed is:

1. An illuminated device comprising:
a housing having:
one or more walls;
an upper portion;
an opening through the upper portion thereof; and
a plurality of stone pieces covering the at least one wall and upper portion of the housing;
one or more light sources positioned within the housing, each of the one or more light sources being configured to emit a light toward at least the one or more walls; and
at least one of a water stream element and a flame element supported within the housing;
wherein:
the stones are at least partially translucent such that the light emitted from the one or more light sources is visible through the stones;
the water stream element is configured to project a stream of water through the opening in the upper portion of the housing to a location outside of the housing; and
the flame element is configured to project a flame through the opening in the upper portion of the housing.

2. The illuminated device of claim 1, comprising a water stream element configured to project a stream of water through the opening in the upper portion of the housing.

3. The illuminated device of claim 2, wherein the one or more light sources are configured to illuminate the stream of water.

4. The illuminated device of claim 2, comprising a pre-programmed or user programmable control system configured to control an amplitude and/or direction of the water stream emitted by the device and the color and frequency of light emitted from the one or more light sources according to a pre-programmed pattern or user controlled pattern.

5. The illuminated device of claim 1, comprising a plurality of water stream elements each configured to project a stream of water through one or more openings in the upper portion of the housing.

6. The illuminated device of claim 1, wherein the water stream element comprises a nozzle, a flow control valve to control a flow of water into the nozzle, and a swivel to permit angular and/or directional adjustability of the nozzle.

7. The illuminated device of claim 5, further comprising a solenoid configured to control a position of the flow control valve.

8. The illuminated device of claim 1, comprising a controller configured to control an operation of the illuminated device, including controlling the amplitude and/or frequency of a continuous or intermittent flow of water out of the water stream element and a color, duration, and/or frequency of the one or more light sources within the housing.

9. The illuminated device of claim 1, comprising a pump configured to provide approximately 5 gallons or more of water per minute to the nozzle.

10. The illuminated device of claim 1, wherein the plurality of stones are attached to a base portion of the housing using the Marquetry Inlay technique.

11. The illuminated device of claim 1, wherein at least one of the one or more light sources, the water stream element, and the flame element are controllable by a controller for a pool.

12. The illuminated device of claim 1, comprising a transformer configured to reduce an input voltage of electricity from approximately 110 volts to approximately 24 volts.

13. The illuminated device of claim 1, wherein the illuminated device is configured to receive a source of pressurized water from a pool pump.

14. The illuminated device of claim 1, comprising a flame monitoring device configured to detect the presence or absence of a flame and send a respective signal to a controller.

15. The illuminated device of claim 1, wherein the illuminated device is configured to emit a plurality of different colored lights.

16. The illuminated device of claim 1, comprising a signal receiver and remote control, the signal receiver being configured to receive a signal from the remote control to control an operation of the device, including operation of the one or more light sources and the flame element or water stream element.

17. A method of controlling the illuminated device of claim 1, comprising controlling a frequency and duration of the one or more light sources and at least one of the water stream element and the flame element using a controller for a pool.

18. An illuminated device, comprising:
a housing having:
one or more walls;
an upper portion;
an opening through the upper portion thereof; and
a plurality of stone pieces covering the at least one wall and upper portion of the housing;
one or more light sources positioned within the housing, each of the one or more light sources being configured to emit a light toward at least the one or more walls; and
a flame element supported within the housing configured to project a flame through the opening in the upper portion of the housing;
wherein:
the stones attached to a base layer of the housing using the Marquetry Inlay technique; and
the flame element comprises an ignition module, a burner, a valve, and a solenoid configured to adjust a position of the valve to control a flow of combustible gas through the burner.

19. The illuminated device of claim 18, wherein the ignition module has a milliamp flame circuit.

20. The illuminated device of claim 18, comprising an automated burner system controlled by a pre-programmed or user programmable control system configured to control an amplitude and/or direction of the flame emitted by the device and the color and frequency of light emitted from the one or more light sources according to a pre-programmed pattern or user controlled pattern.
